(19) United States
(12) Patent Application Publication
(10) Pub. No.: US 2012/0224223 A1
(43) Pub. Date: Sep. 6, 2012

(54) PRINTER AND DATA WRITING METHOD IN THE PRINTER

(75) Inventor: Kenta Yamamoto, Shizuoka (JP)

(73) Assignee: TOSHIBA TEC KABUSHIKI KAISHA, Tokyo (JP)

(21) Appl. No.: 13/409,321

(22) Filed: Mar. 1, 2012

(30) Foreign Application Priority Data
Mar. 4, 2011 (JP) 2011-048258

(51) Int. Cl. G06K 7/01; G06F 3/12

(52) U.S. Cl. 358/1.15

(57) ABSTRACT

A printer includes a print unit, a conveying unit, an antenna unit and a moving unit. The print unit is configured to print on a recording medium having a wireless tag. The conveying unit is configured to convey the recording medium along a conveying path to the print unit. The antenna unit is disposed on the conveying path and configured to write data to the wireless tag by radiating electromagnetic waves. The moving unit is configured to move the antenna unit on the conveying path in a direction perpendicular to a direction in which the recording medium is conveyed.

### CROSS-REFERENCE TO RELATED APPLICATION

This application is based upon and claims the benefit of priority from Japanese Patent Application No. 2011-048258, filed on Mar. 4, 2011, the entire contents of which are incorporated herein by reference.

### FIELD

Embodiments described herein relate to a printer, which prints on a recording medium having a wireless tag and writes data to the wireless tag, and a method of data writing using the printer.

### BACKGROUND

Recently, as the functions of printers become increasingly complicated and diversified, various types of printing processes are becoming possible. Therefore, for example, a wireless tag may be embedded in a sheet of paper, and operations of printing on the paper may be performed while writing data to the wireless tag via an antenna.

When a printer is used to print on a recording medium as well as write data to a wireless tag of the recording medium, the positional relationship between the wireless tag and an antenna transmitting data to the wireless tag may not be properly adjusted for such data writing process. For example, the orientation and direction of the wireless tags can vary to be oriented either longitudinally or laterally. Also, the sizes and shapes of the wireless tags are not consistent.

### BRIEF DESCRIPTION OF THE DRAWINGS

FIG. 1 is a view showing an example of the external appearance of a printer.

FIG. 2 is an explanatory view showing an example of the interior of the printer.

FIG. 3 is a side view showing an example of the mechanical internal structure of the printer.

FIG. 4 is a block diagram showing an example of the electrical configuration of the printer.

FIGS. 5A and SB are an explanatory view in which a dedicated wireless tag antenna in the printer is arranged in the lateral direction, respectively.

FIGS. 6A and 6B are an explanatory view in which the dedicated wireless tag antenna in the printer is arranged in the longitudinal direction, respectively.

FIGS. 7A to 7C are an explanatory view in which the dedicated wireless tag antenna in the printer is rotated, respectively.

### DETAILED DESCRIPTION

According to one embodiment of the present disclosure, a printer includes a print unit, a conveying unit, an antenna unit and a moving unit. The print unit prints on a recording medium having a wireless tag. The conveying unit conveys the recording medium along a conveying path to the print unit. The antenna unit disposed on the conveying path is configured to write data to the wireless tag by radiating electromagnetic waves. Further, the moving unit moves a position of the antenna unit along the conveying path to a position perpendicular to a direction in which the recording medium is conveyed.

Embodiments will now be described in detail with reference to the drawings.

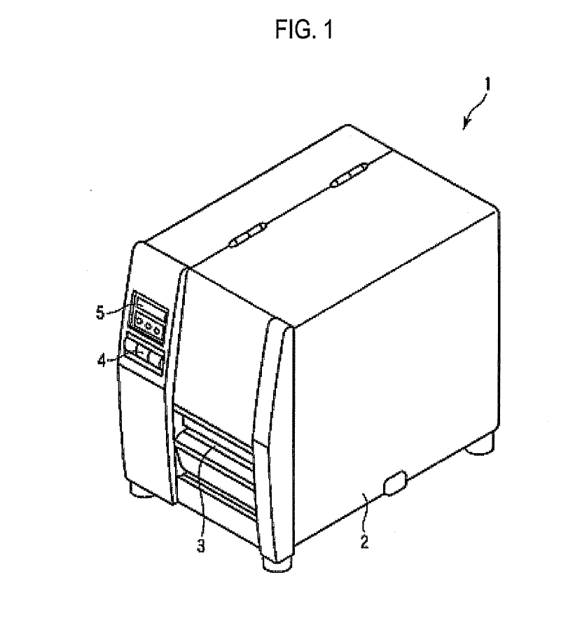

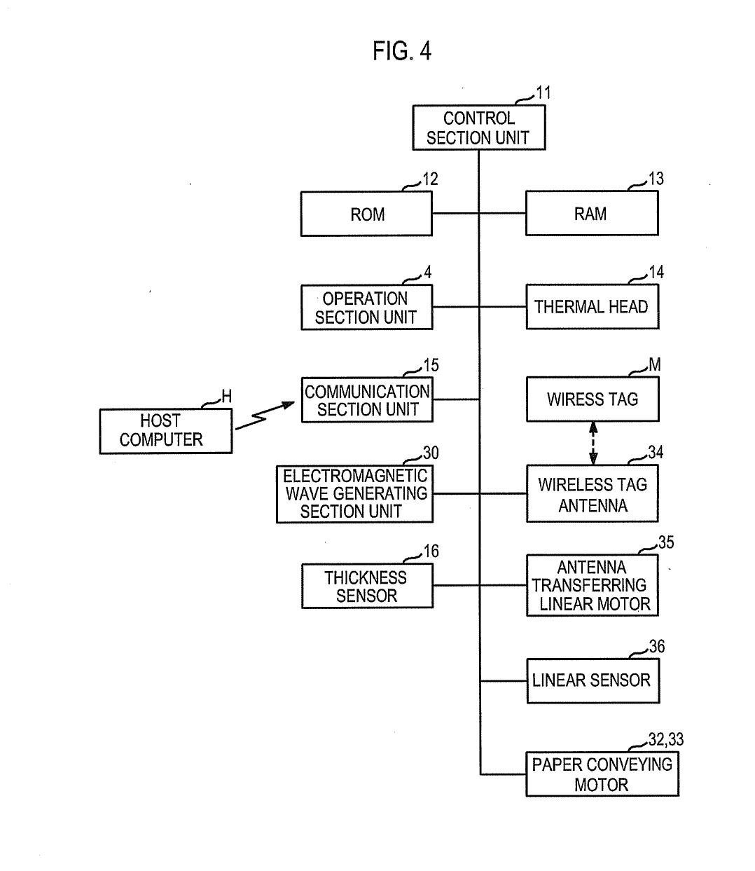

A printer 1 according to one embodiment will now be described in detail with reference to FIGS. 1 to 4.

Referring to FIGS. 1 to 4, the printer 1 according to one embodiment includes a control unit 11, which controls the operation of the printer 1. An operation unit 4, which is disposed in the front part of the printer 1, may be operated to receive an instruction from a user, and supply operation signals to the control unit 11 based on the received instruction. In the printer 1, a display unit 5, which displays operation information, an operation menu and the like, is implemented using a liquid crystal screen etc. The printer 1 further includes a Read Only Memory (ROM) 12 configured to store the operation information, setting information, operation programs etc., and a Random Access Memory (RAM) 13. A thermal head 14, which is controlled by the control unit, prints on a recording medium such as paper. A communication unit 15, which is operated to communicate with an external host computer H etc., inputs print issue commands and information on the recording medium when operated by the user. The printer 1 further includes a thickness sensor 16 configured to detect a thickness of the recording medium. In one embodiment, detection of the thickness may be implemented using a photo sensor configured to output different electric signal depending on the type and thickness of the recording medium.

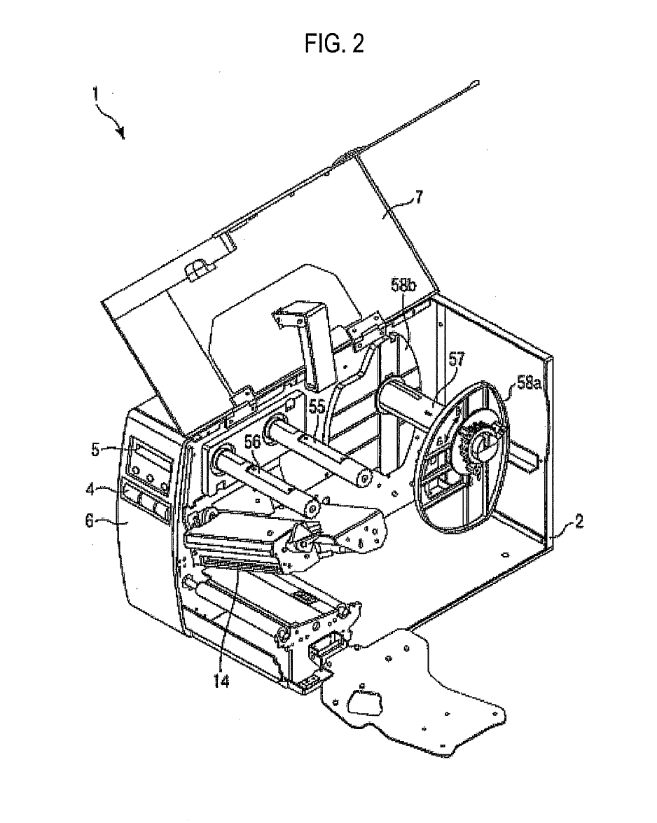

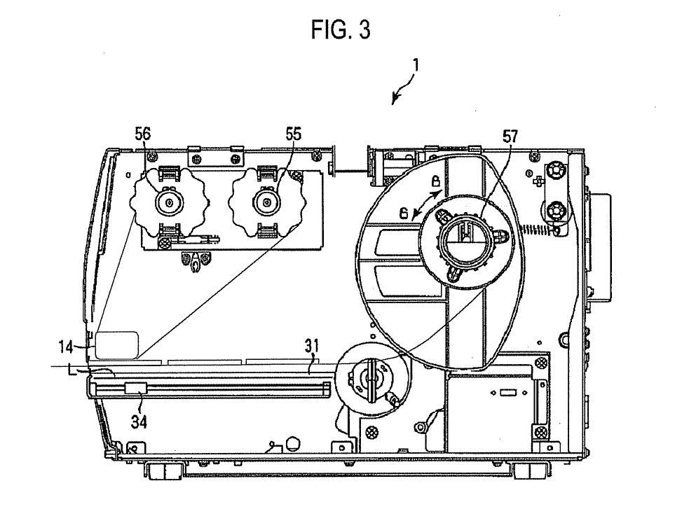

In addition, the printer 1 includes an electromagnetic wave generating unit 30, which generates electromagnetic waves for carrying data to be written to a wireless tag M. A conveying path 31 and paper conveying motors 32 and 33 to convey the recording medium such as the paper are provided within the printer 1. A wireless tag antenna 34 is configured to receive electromagnetic waves from the electromagnetic wave generating unit 30 and radiates the electromagnetic waves so that they are written in the wireless tag M. An antenna transferring linear motor 35 serves to move the wireless tag antenna 34, and a linear sensor 36 detects the current position of the wireless tag antenna 34. Here, the wireless tag M has an IC chip and an antenna for receiving the electromagnetic waves from the wireless tag antenna 34. In addition, in FIGS. 2 and 3, a ribbon supply shaft 55, a ribbon winding shaft 56, a paper support shaft 57 and a pair of side fences 58a and 58b are shown.

Under the control of the control unit 11 and in response to the operation of the operation unit 4 or the host computer H, the printer 1 having the foregoing configuration prints, for example, price information on a recording medium such as paper using the thermal head 14 and conveys the printed paper using the paper conveying motors 32 and 33. The printer 1 then discharges the printed paper.

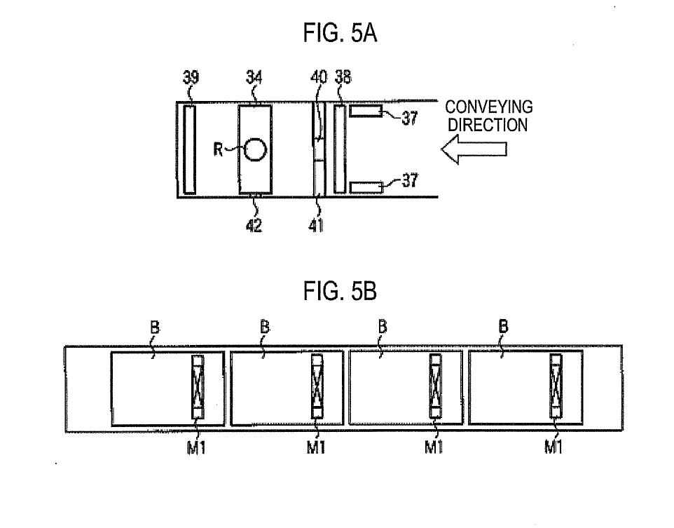

In addition, as an example of the paper handled by the printer 1, a recording medium B with the wireless tag M attached thereto is shown in FIGS. 5A and 5B. In this embodiment, data is written to the wireless tag M via the wireless tag antenna 34 of the printer 1. However, in some other embodiments, the printer 1 may perform printing on the recording medium B to which the wireless tag M is not attached.

Next, the process of writing data in the wireless tag using the printer 1 according to this embodiment will now be described in detail. If printing on the recording medium B with the wireless tag M attached thereto and writing data in the wireless tag M are simultaneously performed, the total processing time will be shortened because the two operations are performed at the same time or in parallel to a certain degree. Therefore, in this embodiment, the process of writing data to the wireless tag M on the recording medium B is performed by sending a signal from the wireless tag antenna 34 in the period during which the recording medium B is conveyed to the thermal head 14 using the paper conveying motors 32 and 33.

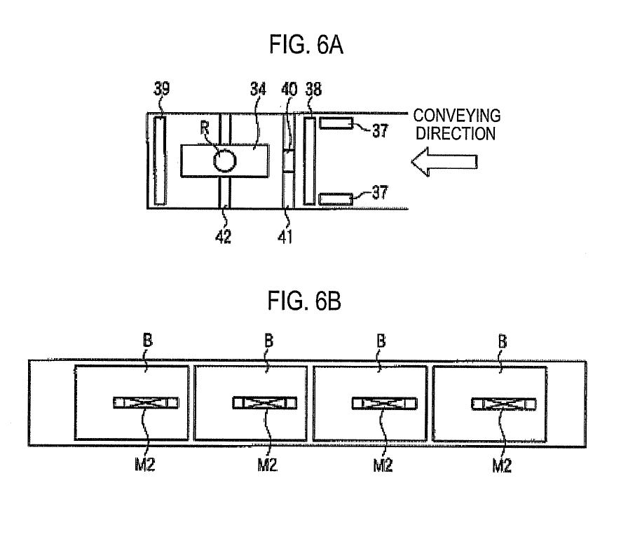

With this configuration, the data writing process using the wireless tag antenna 34 may not be performed with required accuracy, depending on the shape, the position, etc. of the wireless tag if the antenna is fixed at a predetermined position. To address this problem, in one embodiment, the printer 1 is configured to adjust the position or direction of the wireless tag antenna 34 depending on the position or direction of the wireless tag M1 on the recording medium B. FIGS. 5A and 5B are explanatory views in which the wireless tag antenna 34 in a printer is arranged in the lateral direction of the printer, which is perpendicular to the paper conveying direction. Further, FIGS. 6A and 6B are explanatory views in which the wireless tag antenna 34 in the same printer is arranged in the longitudinal direction of the printer. As shown in FIG. 5A, the direction of the wireless tag antenna 34 may be suitably adjusted in alignment with the direction of a wireless tag M1 on a recording medium B, which is perpendicular to the conveying direction of the recording medium B, as in FIG. 5B. Also, as shown in FIG. 6A, the direction of the wireless tag antenna 34 may be adjusted in alignment with the direction of a wireless tag M2 on a recording medium B, which is in parallel to the conveying direction of the recording medium B as shown in FIG. 6B.

Specifically, the printer 1 is configured to adjust the position or direction of the wireless tag antenna 34 depending on the position or direction of the wireless tag M1 on the recording medium B, as follows. As shown in FIGS. 5A to 7C, the printer 1 includes, on a conveying path of the recording medium B, a plurality of paper guides 37, which are configured to support the recording medium B. The printer 1 further includes an upstream roller 38 and a downstream roller 39 configured to convey and support the recording medium B. A sensor 40 is disposed between the two rollers 38 and 39 to detect the wireless tag M1 or M2 (which is collectively referred to as “wireless tag M”). For example, the sensor 40 may be implemented using a photo sensor. The photo sensor may include a light transmitting unit configured to transmit a light towards a target object such as the wireless tag M in the recording medium B, and a light receiving unit configured to receive the light reflected by the target. Since the wireless tag M contained in the recording medium B has a greater thickness than the recording medium B, the wireless tag M has a greater light reflection rate than the recording medium B, and thus the sensor 40 can detect the existence of the wireless tag M by detecting the difference in light transmittance rate. In addition, the sensor 40 may not be limited to the above type of sensor, but may be implemented any other types of suitable sensors such as pressure sensors, magnetic sensors, etc.

Further, a sensor support 41 is provided to move the sensor 40 in a direction perpendicular to the conveying direction of the recording medium B. A rotary shaft R is provided in a center portion of the wireless tag antenna 34, such that the rotary shaft R can rotate to adjust the direction of the wireless tag antenna 34 to be either perpendicular or parallel to the conveying direction of the recording medium B. In addition, a support shaft 42, which is configured to be driven by the antenna transferring linear motor 35, supports the rotary shaft R to move the wireless tag antenna 34 in a direction perpendicular to the conveying direction of the recording medium B, while maintaining a predetermined gap between the wireless tag antenna 34 and the recording medium B. In some other embodiments, the sensor support 41, the rotary shaft R and the support shaft 42 may be configured in a different manner, such that the direction of the wireless tag antenna 34 can be adjusted in other direction than the direction perpendicular or parallel to the conveying direction of the recording medium B.

Using the above-described configuration, the user can change the position of the wireless tag antenna 34 to any position along the support shaft 42. In other words, as shown in FIG. 5B, if the wireless tag M1 on the recording medium B is oriented perpendicular to the conveying direction of the recording medium B, the longitudinal direction of the wireless tag antenna 34 is also adjusted, in the same fashion, to be perpendicular to the conveying direction of the recording medium B. Consequently, the accuracy of writing data from the wireless tag antenna 34 can be improved.

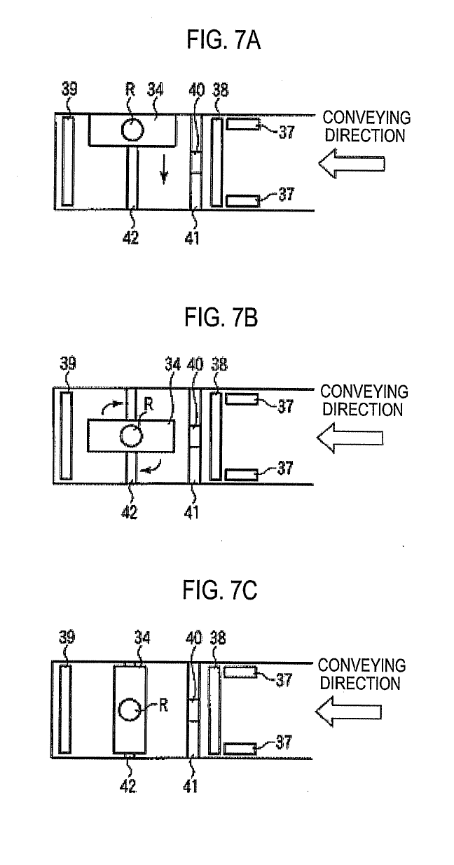

Likewise, as shown in FIG. 6B, if the wireless tag M1 on the recording medium B is oriented to be parallel to the conveying direction of the recording medium B, the longitudinal direction of the wireless tag antenna 34 is also reoriented so as to be parallel to the conveying direction of the recording medium B. This process may be performed in an order inverse to the processes shown in FIGS. 7A to 7C. Consequently, the accuracy of writing data from the wireless tag antenna 34 can be improved.

The above-described embodiment may be implemented by the user manually changing the direction or the position of the wireless tag antenna 34.

In an alternative embodiment, the movement or direction of the wireless tag antenna 34 may be controlled in response to an instruction signal from the operation unit 4 by installing, for example, a linear motor and a linear sensor on the support shaft 42, or installing a rotary motor and an encoder on the rotary shaft R, and controlling them using the control unit 11. That is, in response to the instruction signal from the operation unit 4, the position or direction of the wireless tag antenna 34 can be automatically adjusted to a desired position or direction, as shown in FIG. 5A or FIG. 6A.

In addition, it is possible to detect the position of the wireless tag M1 on the recording medium B by further installing a linear motor and a linear sensor on the sensor support 41 and moving the sensor 40 via the sensor support unit 41 under the control of the control unit 11. The control unit 11 may guide the wireless tag antenna 34 to a suitable position using the rotary shaft R and the support shaft 42, depending on the result of the detection.

In this embodiment, it is not necessary for the user to identify the position of the wireless tag M with his/her eyes and manually guide the wireless tag antenna 34 to the identified position of the wireless tag M. Rather, the user may merely manipulate an operation unit (not shown) to send an instruction signal to the control unit 11 to automatically determine a suitable position and guide the wireless tag antenna 34 to the suitable position. Thus, the control unit 11 can automatically identify the position of the wireless tag M by using the sensor 40 and then guide the wireless tag antenna 34 to the identified position of the wireless tag M. Consequently, it is possible to provide a printer that does not require the user to identify the position of the wireless tag M, while improving the accuracy of the data writing process.

While certain embodiments have been described, these embodiments have been presented by way of example only, and are not intended to limit the scope of the inventions. Indeed, the novel apparatus and method described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a print unit configured to print on a recording medium including a wireless tag;
a conveying unit configured to convey the recording medium along a conveying path to the print unit;
an antenna unit configured to write data to the wireless tag by radiating electromagnetic waves, the antenna unit disposed on the conveying path; and
a moving unit configured to move a position of the antenna unit on the conveying path in a direction perpendicular to a direction in which the recording medium is conveyed.

2. The printer of claim 1, wherein the moving unit comprises a rotating unit configured to rotate the antenna unit to set a direction of a longer side of the antenna unit to be parallel or perpendicular to the direction in which the recording medium is conveyed.

3. The printer of claim 2, wherein the rotating unit comprises:
a rotary shaft configured to rotate the antenna unit so that a direction of a longer side of the antenna unit is set to be parallel or perpendicular to the direction in which the recording medium is conveyed; and
a rotary motor configured to drive the rotary shaft.

4. The printer of claim 3, wherein the moving unit comprises:
a support shaft configured to support the rotary shaft to move the antenna unit in a direction perpendicular to the direction in which the recording medium is conveyed;
a linear motor configured to drive the support shaft; and
a linear sensor configured to detect a current position of the antenna unit.

5. The printer of claim 1, further comprising:
a sensor configured to detect the wireless tag on the conveying path; and
a sensor displacement unit configured to displace the sensor so that the sensor is displaced on the conveying path to be perpendicular to the direction in which the recording medium is conveyed.

6. The printer of claim 5, further comprising a control unit configured to control the moving unit to move the position of the antenna unit based on the position of the wireless tag detected by the sensor.

7. The printer of claim 1, further comprising an electromagnetic wave generating unit configured to generate electromagnetic waves carrying data to be written to the wireless tag, and transmit the electromagnetic waves to the antenna unit.

8. A data writing method in a printer configured to perform printing on a recording medium including a wireless tag, the method comprising:
moving a position of an antenna unit along a direction on an conveying path of the printer, the direction being perpendicular to a direction in which the recording medium is conveyed; and
writing data, by the antenna unit, to the wireless tag, while conveying the recording medium along the conveying path to a printing unit.

9. The method of claim 8, wherein moving comprises rotating the antenna unit in a direction such that a longer side of the antenna unit is parallel or perpendicular to the direction in which the recording medium is conveyed.

10. The method of claim 8, further comprising detecting the wireless tag on the conveying path by a sensor and displacing the sensor so that the sensor is displaced on the conveying path to be perpendicular to the direction in which the recording medium is conveyed.

11. The method of claim 10, further comprising controlling the moving unit to move the position of the antenna unit based on the position of the wireless tag detected by the sensor.

12. The method of claim 8, further comprising generating the electromagnetic waves carrying data to be written to the wireless tag and transmitting the electromagnetic waves to the antenna unit.
